(19) United States
(12) Patent Application Publication
(10) Pub. No.: US 2025/0220104 A1
(43) Pub. Date: Jul. 3, 2025

(54) Selecting a Contact from a Primary Digital Communication Device and Completing the Call Through a Different Communication Device

(71) Applicant: Padmanabhan Mahalingam, Chennai (IN)

(72) Inventor: Padmanabhan Mahalingam, Chennai (IN)

(21) Appl. No.: 18/397,434

(22) Filed: Dec. 27, 2023

(51) Int. Cl. H04M 1/72412; H04M 1/27453; H04M 1/57

(52) U.S. Cl. CPC H04M 1/72412; H04M 1/27453; H04M 1/575

(57) ABSTRACT

A telephony system has a primary digital communication device associated with a caller, the primary digital communication device executing a mobile application, a digital communication device accessible to the user other than the primary digital communication device, and a near-field wireless network coupling the primary digital communication device and the communication device other than the primary digital communication device. The caller, logged into the mobile application, selects a contact from a contact list in the primary digital communication device, and the mobile application, through the near-field wireless connection, causes the digital communication device other than the primary digital communication device to place the call.

### BACKGROUND OF THE INVENTION

### 1. Field of the Invention

The present invention is in the technical field of telephony and pertains more particularly to a system and method for initiating a call by a user from a cell phone contact list and implementing the call with the user on a different communication device, such as landline phone.

### 2. Description of Related Art

The technology of placing calls from a cell phone through a cell network to either a landline phone or another cell phone is well-known in the art. Typically a user (caller) may select a recipient from a contact list stored on the user's cell phone, and the call will be implemented through the user's cellular network to a communication device associated with the recipient. If and when the recipient answers the caller and the recipient may converse.

Use of a server to place a call to a plurality of end points is also known in the art as witnessed by U.S. Pat. No. 9,578,178 to the applicant of the instant application as inventor. It is also known in the art that voice quality and volume may generally be better on a landline device through a land line than on a cellular phone through a cell network. A user with a cell phone may have reasons as well for completing the call with a communication device other than a landline telephone, such as a different cell phone or a pad device, or any other communication device.

What is clearly needed is a system enabling a first user (caller) to place a call to a destination number from a number in the contact list in the user's cellular telephone and completing the call with the first user on a different locally accessible device, such as a landline telephone or any other accessible communication device.

### BRIEF SUMMARY OF THE INVENTION

In an embodiment of the invention a telephony system is provided, comprising a primary digital communication device associated with a caller, and executing a mobile application, a digital communication device accessible to the user other than the primary digital communication device, and a near-field wireless network coupling the primary digital communication device and the digital communication device other than the primary digital communication device. The caller, logged into the mobile application, selects a contact from a contact list in the primary digital communication device, and the mobile application, through the near-field wireless connection, causes the digital communication device other than the primary digital communication device to place the call.

In one embodiment the primary digital communication device is a smartphone. Also, in one embodiment the caller has more than one accessible digital communication device other than the primary digital communication device coupled to the primary digital communication device on the near-field wireless network and the caller is enabled by the mobile app to select a device to place the call. In one embodiment the caller is enabled by the mobile application to select or enter a caller ID to be displayed to the recipient of the call. And in one embodiment the near-field wireless network is a Bluetooth™ network.

In one embodiment the digital communication device other than the primary digital communication device is not coupled to the near field wireless network, and the primary digital communication device sends a request through a cellular network and a cellular base station to an Internet connected server to implement the call, and the Internet-connected server places a first call to the communication device other than the primary digital communication device, a second call to the recipient, and connects the first and the second call, enabling the caller to converse with the recipient on the digital communication device other than the primary digital communication device. Also, in one embodiment the digital communication device accessible to the user other than the primary digital communication device is a landline telephone connected to a landline telephone exchange, and the call is placed by the landline telephone through the landline exchange. In one embodiment the digital communication device other than the primary digital communication device is a pad device connected to the Internet network by a WiFi network and adapted for Voice Over IP (VOIP), also coupled to the primary digital communication device on the near-field wireless network, and the mobile application causes the pad device to place the call. And in one embodiment the digital communication device other than the primary digital communication device is a laptop or a desktop computer connected through an ISP to the Internet, the computer having a telephony application and enabled for VoIP, the computer also coupled to the cellular telephone on the near-field wireless network, and the mobile application causes the laptop or the desktop computer to place the call.

In another aspect of the invention a telephony method is provided, comprising selecting a contact from a contact list in a primary digital communication device executing a mobile application, and causing a digital communication device accessible to the caller other than the primary digital communication device and coupled to the primary digital communication device on a near-field network, by instruction from the mobile application, to place a call to the number of the contact selected.

In one embodiment of the method the primary digital communication device is a smartphone, comprising causing a digital communication device accessible to the caller other than the smartphone and coupled to the smartphone on a near-field network, by instruction from the mobile application, to place a call to the number of the contact selected. Also, in one embodiment the caller has more than one accessible digital communication device other than the primary digital communication device coupled to the primary digital communication device on the near-field wireless network, comprising the caller selecting a device through display by the mobile application to place the call. Also, in one embodiment the method comprises the caller selecting a caller ID to be displayed to the recipient of the call. In one embodiment the method comprises enabling the near-field wireless network as a Bluetooth™ network.

In one embodiment of the method the digital communication device other than the primary digital communication device is not coupled to the near field wireless network, comprising the primary digital communication device sending a request through a cellular network and a cellular base station to an Internet connected server to implement the call, and the Internet-connected server placing a first call to the communication device other than the primary digital communication device, a second call to the recipient, and connecting the first and the second call, enabling the caller to converse with the recipient on the digital communication device other than the primary digital communication device. Also, in one embodiment the digital communication device accessible to the user other than the primary digital communication device is a landline telephone connected to a landline telephone exchange, comprising placing the call by the landline telephone through the landline exchange. In one embodiment the digital communication device other than the primary digital communication device is a pad device connected to the Internet network by a WiFi network and adapted for Voice Over IP (VOIP), also coupled to the primary digital communication device on the near-field wireless network, comprising the mobile application causing the pad device to place the call. And in one embodiment the digital communication device other than the primary digital communication device is a laptop or a desktop computer connected through an ISP to the Internet, the computer having a telephony application and enabled for VoIP, the computer also coupled to the primary digital communication device on the near-field wireless network, comprising the mobile application causing the laptop or the desktop computer to place the call.

### BRIEF DESCRIPTION OF THE SEVERAL VIEWS OF THE DRAWINGS

FIG. 1 is a diagram of a telephony system according to an embodiment of the present invention.

FIG. 2 is a diagram illustrating selection of a recipient of a call and entry of data.

FIG. 3 is a flow diagram depicting a method of placing a call in a system according to an embodiment of the invention.

### DETAILED DESCRIPTION OF THE INVENTION

It is well known in the art that most individuals and employees in businesses have access to more than one communication device, such a smartphone. An individual in a conventional residence may, for example, have a smartphone with a contact list that may enable the individual to select a recipient for an outgoing call, and to place the call from the smartphone. The same individual may also have a pad device, a personal digital assistant (PDA), a desktop computer, a laptop computer, and one or more landline telephones connected to a landline exchange. Different individuals may well have a different mixture of digital devices that may be capable of hosting voice communication with a recipient of a call.

Typically, it is only the smartphone that has a contact list and the ability to select a recipient from the contact list to initiate an outgoing call. The present inventor has determined that there may be good reasons for an individual with a smartphone and access to other digital communication devices to desire the convenience of selecting a recipient from the contact list but implementing the call through a different accessible communication device. It is well-known, for example, that voice quality and volume is generally better on a landline device through a land line connection than on a cellular phone through a cell network. There may also be a variety of other reasons for completing a call through a different communication device than the caller's cell phone which may be leveraged to select a recipient for a call from a contact list.

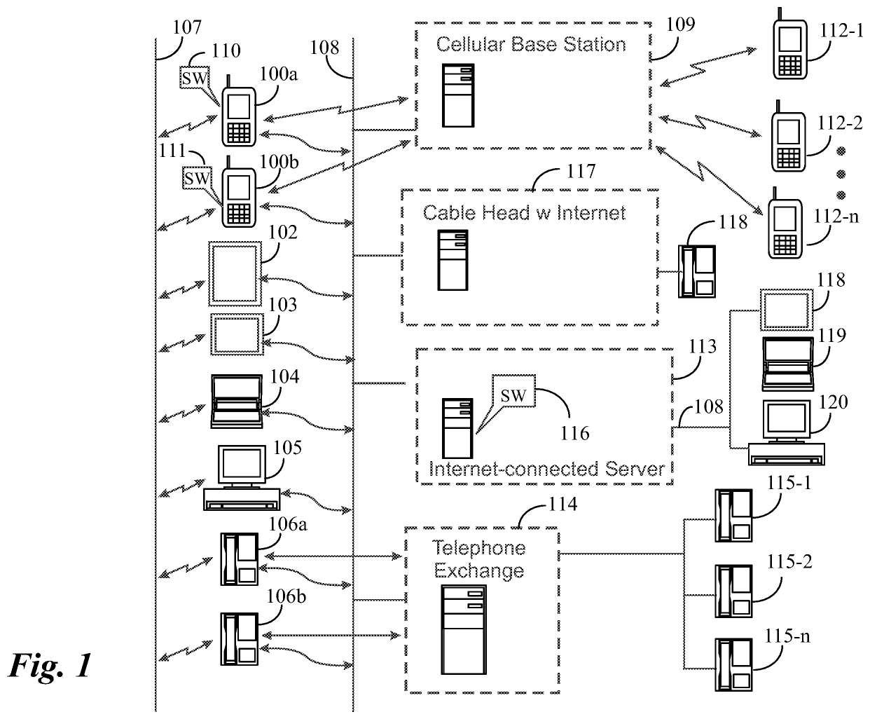

FIG. 1 is diagram of a telephony system according to an embodiment of the present invention, wherein a caller has at least one primary digital communication device storing a contact list. Most usually this primary device is a smartphone 100a, that may execute a software mobile application (SW) 110 and has access to a contact list. The caller may well have an accessible second primary device 100b that may also be a smartphone, or similar digital device, and the cellular phones or devices store a contact list. The caller may have access as well to a pad device 102, a PDA device 103, a laptop computer 104, a desktop computer 105 and one or more landline telephones such as telephones 106a and 106b. It should be noted that the mix of accessible devices may be different for different callers.

In an embodiment of the invention the caller's accessible devices are coupled wirelessly through a wireless network represented by line 107. In one embodiment one or both of landline telephones 106a and 106b may be enabled for wireless coupling through network 107 and may be enabled to be leveraged by device 100a, which may be a smartphone, executing mobile application 110 to place a call to a recipient selected from a contact list in the smartphone.

Calls from the caller's primary devices 100a or 100b are typically placed wirelessly through a cellular network to a cellular base station 109 hosted by a cellular enterprise such as Verizon™ for example. Base station 109 may place calls through the cellular network to cellular telephones 112-1 through 112-n. Base station 109 is also connected to the well-known Internet network represented by line 108. Base station 109 may also represent different cellular base stations perhaps hosted by other cellular enterprises.

In an embodiment of the invention all of the caller's devices are shown to be coupled wirelessly through network 107, which may be a well-known Bluetooth™ network, but may also be another near-field or far-field wireless protocol. All the devices may also be coupled by a WiFi network through Internet service providers (ISPs) (not shown) to the well-known Internet network represented by lines 108. Lines 108 represent all of the networks, subnetworks and connections in the Internet network.

Telephones 106a and 106b are connected through conventional telephone lines to a telephone exchange 114 through which landline calls may be placed and conducted to a plurality of landline telephones 115-1 through 115-n.

An Internet-connected server 113 is accessible over the Internet connection 108 by individual ones of the caller's accessible devices and may be leveraged to place calls to such as pad devices 118, laptop computers 119 and desktop computers 120. Server 113 executing software 116 may also access telephone exchange 114 and place calls back to one of the caller's accessible landline telephones 106a or 106b. For a pad device to make calls the device must either have a SIM card and cellular capability to make calls over a cellular network or must be enabled for Voice Over IP (VOIP) and be connected to the Internet network. To use a laptop or a desktop computer to place calls, the computer must be connected to the Internet network and must be enabled for VOIP with an app to manage calls.

Also illustrated in FIG. 1 is a cable head 117 with Internet connection representing such as Direct TV, for example, through which digital communication may be accomplished to such as a landline telephone 118.

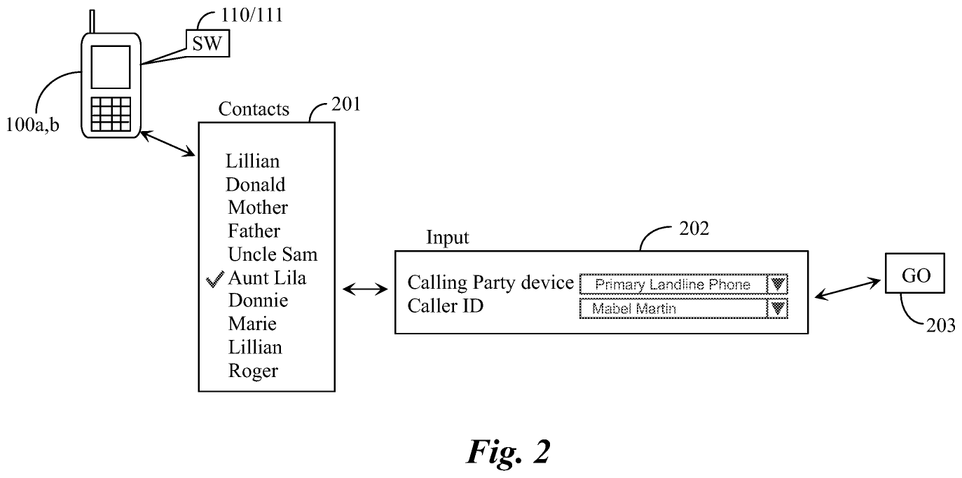

In embodiments of the invention a caller, having a desire to place a call to a recipient listed in a contact list of the caller's smartphone, logs into mobile app 110 on primary device 100a or mobile app 111 on primary device 100b, or the mobile app may be executing in the background. The caller selects a recipient in the contact list. See FIG. 2. In FIG. 2 the caller selects Aunt Lila. The mobile app displays an interactive interface 202 on the display of the primary device, which has at least input fields for a calling party device and a Caller ID number. In embodiments of the invention there may be defaults for both the calling party device and the Caller ID to display to a recipient and the caller need not make any entry. If the caller wishes to change either the calling party device or the ID there may be drop-down menus. If the caller is satisfied with the calling party device and the Caller ID the mobile app causes a radio button 203, in this example, to display, which the caller may select to initiate the call.

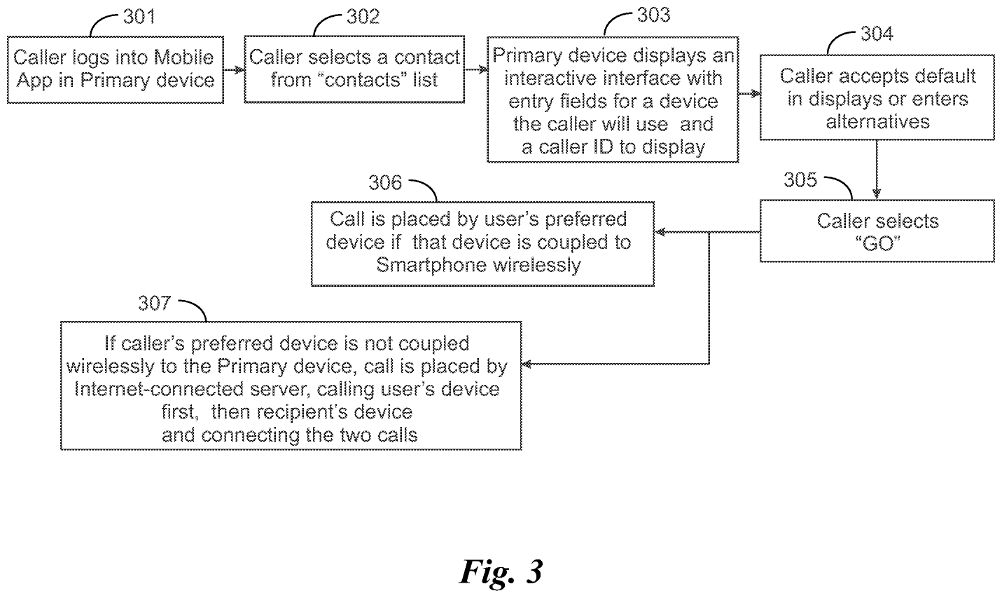

FIG. 3 is a flow diagram illustrating a method in an embodiment of the invention. At step 301 a caller logs into a mobile application on the caller's primary device. At step 302 the caller selects a contact from the contact list in the primary device. At step 303 the primary device displays an interactive interface with entry fields for at least the device the caller wishes to use in the call, and a caller ID to display to the recipient of the call. At step 304 the caller accepts defaults in the display or selects changes. At step 305 the caller selects to place the call. At step 306, if the device selected to use by the caller is wirelessly connected with the primary device, the selected device places the call to the recipient. At step 307, if the device selected for the caller to use is not wirelessly connected to the primary device, a request is sent to an Internet-connected server that places a call to the users selected device to use first, a second call to the recipient, and connects the two calls.

The operation under different circumstances is best explained by a following set of examples:

Example 1: Caller wants to make the call from the caller's accessible Landline telephone 106a, which is coupled to primary device 100a on Bluetooth network 107 and is enabled to place calls initiated by SW 110.
A. Caller opens mobile app 110.
B. Caller selects recipient for the call from contact list. The recipient's number in this example is for a cell phone.
C. Caller views calling party device and Caller ID and is satisfied that both are correct, or changes.
D. Caller selects “Go” in display.
E. Landline phone 106a places the call through telephone exchange 114 which competes the call over Internet to the Cellular Base station to recipient's cell phone, which displays the Caller ID.
   Example 2: Caller wants to make the call from Landline telephone 106a, which is coupled to primary device 100a on Bluetooth network 107 and is enabled to place calls initiated by SW 110.
A. Caller opens mobile app 110.
B. Caller selects recipient for the call from contact list. The recipient's number is for a landline telephone.
C. Caller views calling party device and Caller ID and is satisfied that both are correct, or changes.
D. Caller selects “Go” in display.
E. Landline phone 106a places the call through telephone exchange 114 directly to recipient's landline telephone, which displays the Caller ID.
   Example 3: Caller wants to make the call from Landline telephone 106b, which is not coupled to primary device 100a on Bluetooth or another wireless network.
A. Caller opens mobile app 110.
B. Caller selects recipient for the call from contact list. The recipient's number is for a landline telephone.
C. Caller views calling party device and Caller ID and is satisfied that both are correct, or changes.
D. Caller selects “Go” in display.
E. Primary device 100a connects to Internet-connected server 113 executing SW 116 and requests a call between Landline Phone 106b and the recipient's landline telephone.
F. Server 113 connects to telephone exchange 114 and places a first call to landline phone 106b, and a second call to the recipient's landline phone, then connects the two calls, enabling the caller to converse with the recipient's landline phone using caller's landline phone 106b.
   Example 4: Caller wants to make the call from Pad device 102.
A. Caller opens mobile app 110.
B. Caller selects recipient for the call from contact list. The recipient's number is for a cellular telephone.
C. Caller views calling party device and Caller ID, selects the Pad device in the dropdown menu and verifies the Caller ID.
D. Caller selects “Go” in display.
E. Primary device 100a instructs Pad device 102 through Bluetooth™ network 107 to place the call.
F. Pad device 102 connects to cellular base station 109 by WiFi to Internet 108 and base station 109 completes the call to recipient's cell phone, enabling the caller to speak with the recipient using the caller's pad device.

There are several other possible circumstances, and with understanding of the above examples the skilled person will understand how calls may completed between any one of the caller's accessible devices, a recipient's landline phone or cell phone, or even a recipient's pad device, laptop, or desktop computer.

A skilled person will understand that the descriptions of embodiments in this specification are all exemplary and are not limiting to the scope of the invention. The scope is limited only by the claims that follow.

1. A telephony system, comprising:
a primary digital communication device associated with a caller, and executing a mobile application;
a digital communication device accessible to the user other than the primary digital communication device; and
a near-field wireless network coupling the primary digital communication device and the digital communication device other than the primary digital communication device;
wherein the caller, logged into the mobile application, selects a contact from a contact list in the primary digital communication device, and the mobile application, through the near-field wireless connection, causes the digital communication device other than the primary digital communication device to place the call.

2. The system of claim 1 wherein the primary digital communication device is a smartphone.

3. The system of claim 1 wherein the caller has more than one accessible digital communication device other than the primary digital communication device coupled to the primary digital communication device on the near-field wireless network and the caller is enabled by the mobile app to select a device to place the call.

4. The system of claim 1 wherein the caller is enabled by the mobile application to select or enter a caller ID to be displayed to the recipient of the call.

5. The system of claim 1 wherein the near-field wireless network is a Bluetooth™ network.

6. The system of claim 1 wherein the digital communication device other than the primary digital communication device is not coupled to the near field wireless network, and the primary digital communication device sends a request through a cellular network and a cellular base station to an Internet connected server to implement the call, and the Internet-connected server places a first call to the communication device other than the primary digital communication device, a second call to the recipient, and connects the first and the second call, enabling the caller to converse with the recipient on the digital communication device other than the primary digital communication device.

7. The system of claim 1 wherein the digital communication device accessible to the user other than the primary digital communication device is a landline telephone connected to a landline telephone exchange, and the call is placed by the landline telephone through the landline exchange.

8. The system of claim 1 wherein the digital communication device other than the primary digital communication device is a pad device connected to the Internet network by a WiFi network and adapted for Voice Over IP (VOIP), also coupled to the primary digital communication device on the near-field wireless network, and the mobile application causes the pad device to place the call.

9. The system of claim 1 wherein the digital communication device other than the primary digital communication device is a laptop or a desktop computer connected through an ISP to the Internet, the computer having a telephony application and enabled for VoIP, the computer also coupled to the cellular telephone on the near-field wireless network, and the mobile application causes the laptop or the desktop computer to place the call.

10. A telephony method, comprising:
selecting a contact from a contact list in a primary digital communication device executing a mobile application; and
causing a digital communication device accessible to the caller other than the primary digital communication device and coupled to the primary digital communication device on a near-field network, by instruction from the mobile application, to place a call to the number of the contact selected.

11. The method of claim 10 wherein the primary digital communication device is a smartphone, comprising causing a digital communication device accessible to the caller other than the smartphone and coupled to the smartphone on a near-field network, by instruction from the mobile application, to place a call to the number of the contact selected.

12. The method of claim 9 wherein the caller has more than one accessible digital communication device other than the primary digital communication device coupled to the primary digital communication device on the near-field wireless network, comprising the caller selecting a device through display by the mobile application to place the call.

13. The method of claim 9 comprising the caller selecting a caller ID to be displayed to the recipient of the call.

14. The method of claim 9 comprising enabling the near-field wireless network as a Bluetooth™ network.

15. The method of claim 9 wherein the digital communication device other than the primary digital communication device is not coupled to the near field wireless network, comprising the primary digital communication device sending a request through a cellular network and a cellular base station to an Internet connected server to implement the call, and the Internet-connected server placing a first call to the communication device other than the primary digital communication device, a second call to the recipient, and connecting the first and the second call, enabling the caller to converse with the recipient on the digital communication device other than the primary digital communication device.

16. The method of claim 9 wherein the digital communication device accessible to the user other than the primary digital communication device is a landline telephone connected to a landline telephone exchange, comprising placing the call by the landline telephone through the landline exchange.

17. The method of claim 9 wherein the digital communication device other than the primary digital communication device is a pad device connected to the Internet network by a WiFi network and adapted for Voice Over IP (VOIP), also coupled to the primary digital communication device on the near-field wireless network, comprising the mobile application causing the pad device to place the call.

18. The method of claim 9 wherein the digital communication device other than the primary digital communication device is a laptop or a desktop computer connected through an ISP to the Internet, the computer having a telephony application and enabled for VoIP, the computer also coupled to the primary digital communication device on the near-field wireless network, comprising the mobile application causing the laptop or the desktop computer to place the call.
